(19) United States
(12) Patent Application Publication
(10) Pub. No.: US 2010/0302125 A1
(43) Pub. Date: Dec. 2, 2010

(54) HIGH-GAIN OMNIDIRECTIONAL ANTENNA MODULE

(75) Inventor: Cho-Hao Chang, Miaoli County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: SMARTANT TELECOM CO., LTD., Hsinchu (TW)

(21) Appl. No.: 12/777,784

(22) Filed: May 11, 2010

(30) Foreign Application Priority Data
May 27, 2009 (TW) 098209508

(51) Int. Cl. H01Q 1/50; H01Q 1/42; H01Q 1/12

(52) U.S. Cl. 343/872; 343/905; 343/878

(57) ABSTRACT

A high-gain omnidirectional antenna module includes a base, an RF power amplifier, an omnidirectional antenna, a first signal line, and a second signal line. The base has a first surface and a second surface. The first signal line delivers a signal fed from outside to an input port of the RF power amplifier, and the second signal line connects an output port of the RF power amplifier and a feed portion of the antenna. The signal is amplified by the RF power amplifier, and thus the gain of the omnidirectional antenna is increased significantly. Therefore, the high-gain omnidirectional antenna effectively increases the transmission distance without increasing the size of the omnidirectional antenna.

### CROSS-REFERENCE TO RELATED APPLICATIONS

This non-provisional application claims priority under 35 U.S.C. §119(a) on Patent Application No(s). 098209508 filed in Taiwan, R.O.C. on May 27, 2009, the entire contents of which are hereby incorporated by reference.

### BACKGROUND OF THE INVENTION

1. Field of Invention

The present invention relates to an antenna module, and more particularly to a high-gain omnidirectional antenna module.

2. Related Art

The telematic system is a technology that integrates information, communication, and electronics, in which antenna is an indispensable element. The antenna used in the telematic system must support the mobility of vehicles. As a directional antenna can transmit signals in only a fixed direction, when the position of the directional antenna is changed, the communication link established by the directional antenna is interrupted. Therefore, the telematic system uses an omnidirectional antenna. Thus, regardless of the direction in which the vehicle moves, the communication link established by the omnidirectional antenna can be maintained continuously, such that the information can be transmitted without interruption.

However, the antenna gain of the omnidirectional antenna in the prior art is low. In order to increase the transmission distance, a high-gain antenna is required. If the antenna gain is increased, the size of the antenna needs to be increased accordingly. However, in consideration of safe driving or appearance of the vehicle, the large-sized antenna is not suitable for being installed on a vehicle. Therefore, it is an important issue for researchers to design a high-gain antenna with a size suitable for being installed on a vehicle.

### SUMMARY OF THE INVENTION

Accordingly, the present invention is a high-gain omnidirectional antenna module, which is capable of performing long-distance transmission. The high-gain omnidirectional antenna module has the characteristic of small size, and is suitable for being installed in a vehicle.

The high-gain omnidirectional antenna module of the present invention comprises a base, a radio frequency (RF) power amplifier, an omnidirectional antenna, a first signal line, and a second signal line. The base has a first surface and a second surface. The first signal line delivers a signal fed from outside to an input port of the RF power amplifier, and the second signal line connects an output port of the RF power amplifier and a feed portion of the antenna.

In an embodiment of the present invention, the RF power amplifier is disposed on a circuit board. The antenna module further comprises a case for supporting the omnidirectional antenna on the circuit board. The antenna module further comprises a plurality of support members, disposed between the circuit board and the first surface of the base. The material of the support members is preferably metal. The antenna module further comprises a cushion, disposed between the omnidirectional antenna and the case. The antenna module further comprises a housing. The first surface of the base comprises a groove, for fixing the housing on the base. The antenna module further comprises a waterproof joint disposed on the second surface. A frequency operating range of the RF power amplifier is between 2.4 GHz and 2.5 GHz.

The signal is amplified by the RF power amplifier, such that the gain of the omnidirectional antenna is increased significantly. Therefore, the high-gain omnidirectional antenna effectively increases the transmission distance without increasing the size of the omnidirectional antenna.

### BRIEF DESCRIPTION OF THE DRAWINGS

The present invention will become more fully understood from the detailed description given herein below for illustration only, and thus are not limitative of the present invention, and wherein:

FIG. 1 is a schematic front view of an embodiment of the present invention;

FIG. 2 is a schematic front view of another embodiment of the present invention;

FIG. 3 is a schematic back view of an embodiment of the present invention;

FIG. 4A is a horizontal pattern diagram of an embodiment of the present invention at an operating frequency of 2.4 GHz when not connected to an RF power amplifier;

FIG. 4B is a horizontal pattern diagram of an embodiment of the present invention at an operating frequency of 2.45 GHz when not connected to an RF power amplifier;

FIG. 4C is a horizontal pattern diagram of an embodiment of the present invention at an operating frequency of 2.5 GHz when not connected to an RF power amplifier;

FIG. 5A is a horizontal pattern diagram of an embodiment of the present invention at an operating frequency of 2.4 GHz when connected to an RF power amplifier;

FIG. 5B is a horizontal pattern diagram of an embodiment of the present invention at an operating frequency of 2.45 GHz when connected to an RF power amplifier; and

FIG. 5C is a horizontal pattern diagram of an embodiment of the present invention at an operating frequency of 2.5 GHz when connected to an RF power amplifier.

### DETAILED DESCRIPTION OF THE INVENTION

The detailed features and advantages of the present invention are described below in great detail through the following embodiments, and the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention. The following embodiments are intended to describe the present invention in further detail, but not intended to limit the scope of the present invention in any way.

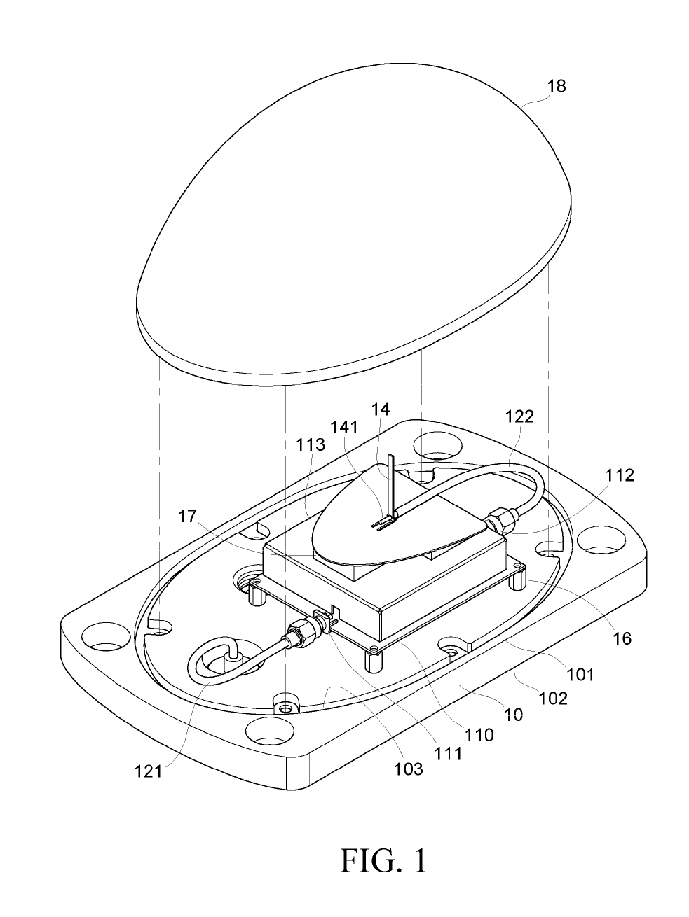

FIG. 1 is a schematic front view of a high-gain omnidirectional antenna module according to an embodiment of the present invention. Referring to FIG. 1, the high-gain omnidirectional antenna module comprises a base 10, an RF power amplifier (not shown), an omnidirectional antenna 14, a first signal line 121, and a second signal line 122. The base 10 has a first surface 101 and a second surface 102. The RF power amplifier (not shown) has an input port 111 and an output port 112. The omnidirectional antenna 14 has a feed portion 141. The first signal line 121 delivers a signal fed from outside to the input port 111 of the RF power amplifier, and the second signal line 122 connects the output port 112 of the RF power amplifier and the feed portion 141 of the omnidirectional antenna.

In an embodiment of the present invention, the antenna module further comprises a circuit board 110. The RF power amplifier (not shown) is disposed on the circuit board 110. The RF power amplifier (not shown) uses an active device to amplify an RF signal, and is disposed on the circuit board 110 as metal circuit wiring. The circuit board 110 has a case 113 disposed thereon, for supporting the omnidirectional antenna 14 on the circuit board 110. The frequency operating range of the RF power amplifier (not shown) is 2.4 GHz-2.5 GHz. The RF power amplifier (not shown) may be a power amplifier of TM-5004 model or other power amplifiers having the same property.

In an embodiment of the present invention, the high-gain omnidirectional antenna further comprises a plurality of support members 16, for supporting the circuit board 110 on the first surface 101 of the base. The material of the support members 16 is preferably metal. The antenna module further comprises a cushion 17, for supporting the omnidirectional antenna 14 on the case 113. As the antenna module is disposed outside a vehicle, in order to prevent rain or sand from damaging the electronic elements in the antenna module, the antenna module further comprises a housing 18. The first surface of the base has a groove 103 for fastening the housing on the base 10.

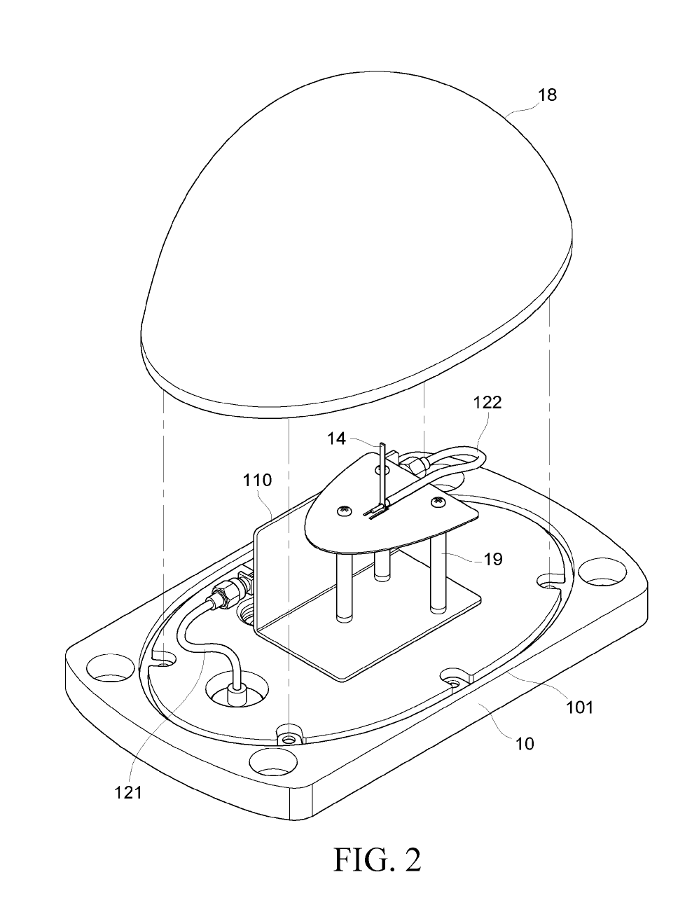

FIG. 2 is a schematic front view of another embodiment of the present invention. The antenna module further comprises a plurality of support members 19, for supporting the omnidirectional antenna 14 on the first surface 101 of the base 10. The support members 19 may be hollow support members, and use screws having a length corresponding to that of the support members 19 to fix the omnidirectional antenna 14 on the support members 19. The circuit board 110 is vertical to the base 10. The first signal line 121 delivers the signal to the power amplifier (not shown) on the circuit board 110, and then the second signal line 122 delivers the amplified signal to the omnidirectional antenna 14.

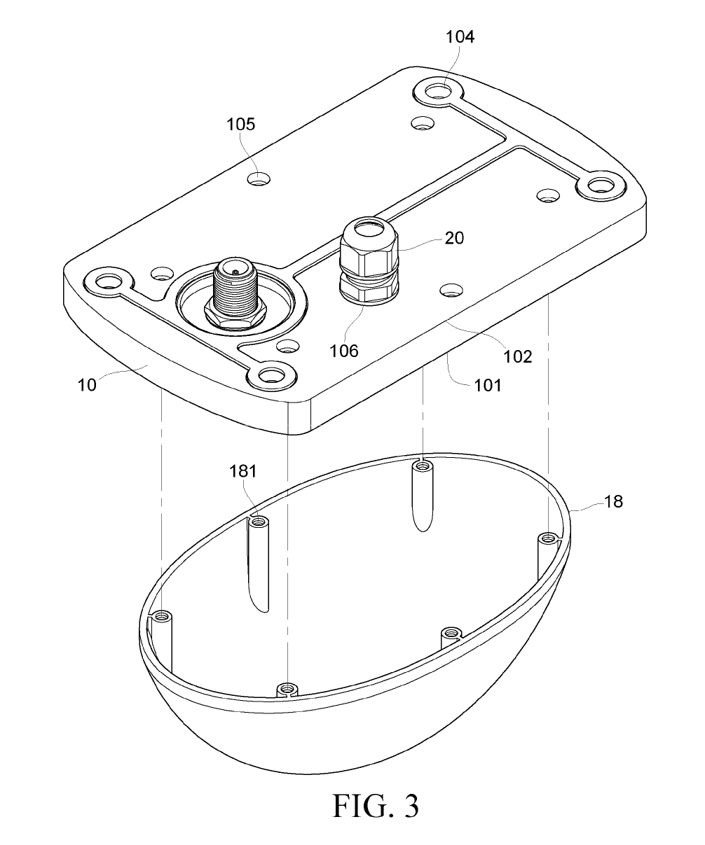

FIG. 3 is a schematic back view of a high-gain omnidirectional antenna module according to an embodiment of the present invention. Referring to FIG. 3, in order to prevent rain from entering the antenna module through the joint and damaging the elements, the base 10 has a plurality of first holes 104, penetrating from the first surface 101 of the base 10 to the second surface 102 of the base 10. A plurality of fixing members, for example, screws, is used to pass through the first holes 104 and fix the antenna module on the outside of a vehicle. The base 10 also has a plurality of second holes 105, penetrating from the first surface 101 of the base 10 to the second surface 102 of the base 10. A plurality of fixing members, for example, screws, is used to pass through the second holes 105 and is fixed the screw holes 181, so as to fix the housing 18 on the base 10. Furthermore, the base 10 further has a third hole 106. The antenna module further comprises a waterproof joint 20, disposed on the second surface 102 of the base 10. For the simplicity and clearness of the drawings, the screws are not shown.

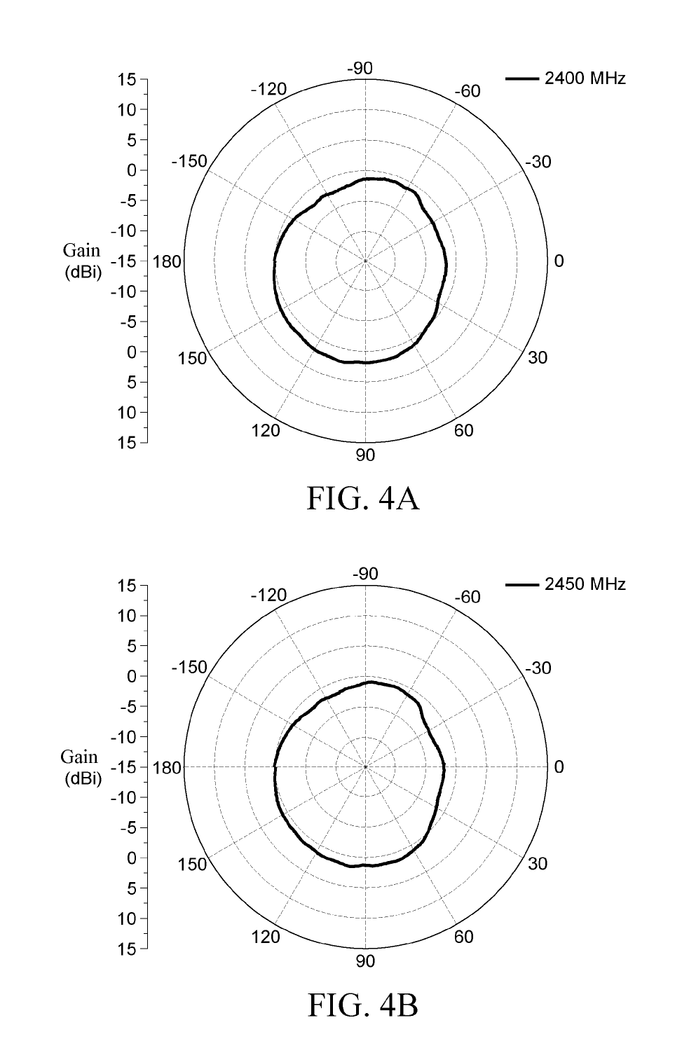

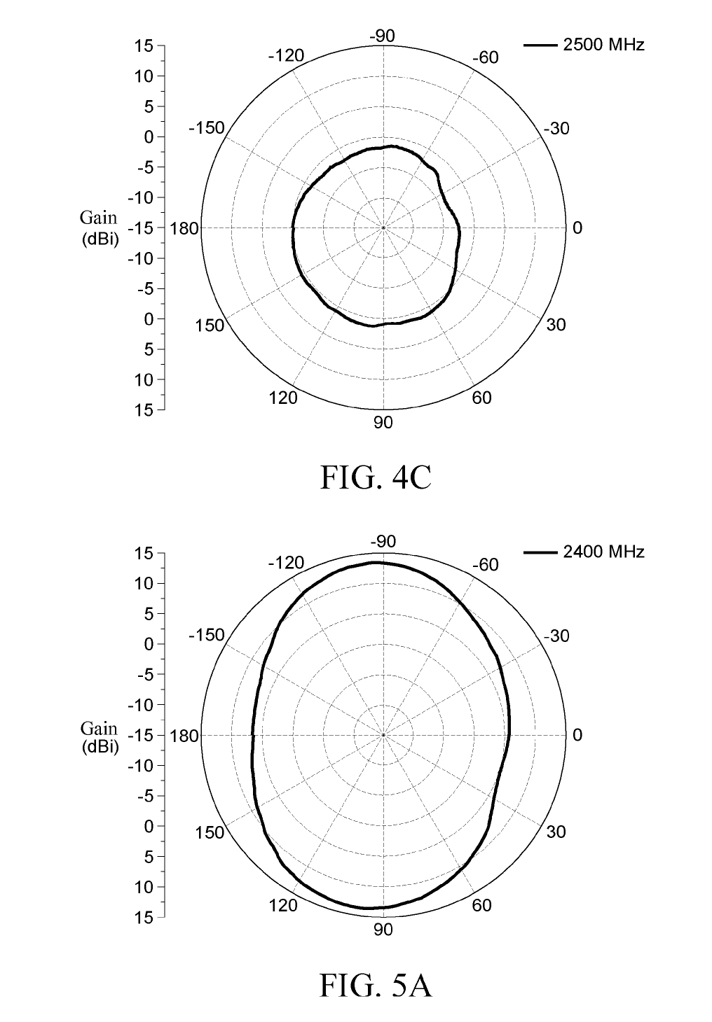

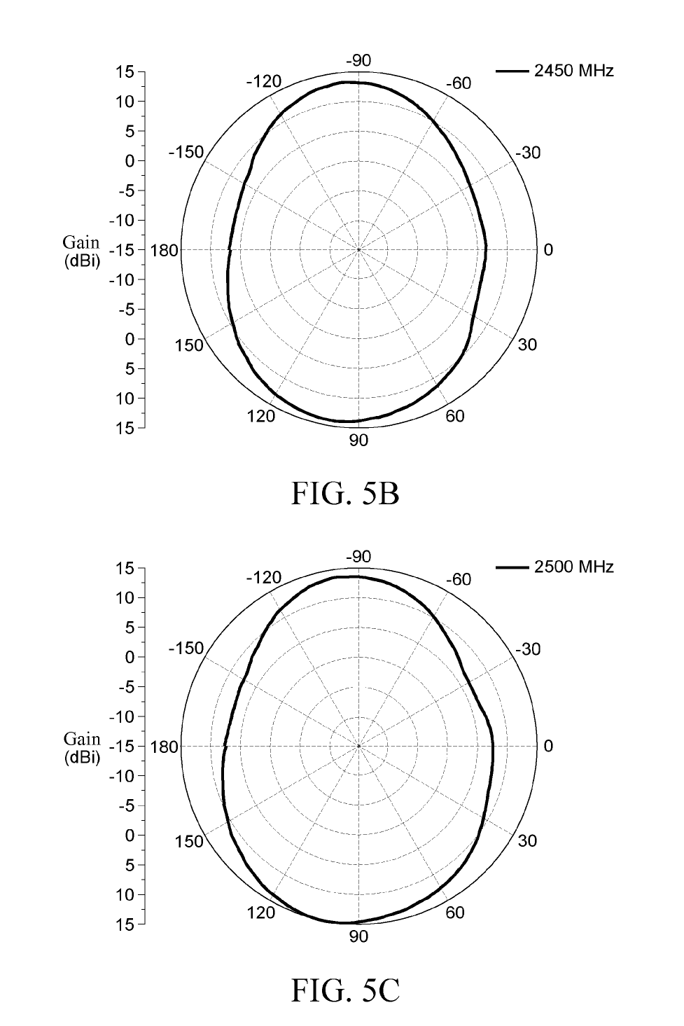

FIGS. 4A, 4B, and 4C are horizontal pattern diagrams of the omnidirectional antenna at operating frequencies of 2.4 GHz, 2.45 GHz, and 2.5 GHz respectively when not connected to an RF power amplifier, and FIGS. 5A, 5B, and 5C are horizontal pattern diagrams of the omnidirectional antenna at operating frequencies of 2.4 GHz, 2.45 GHz, and 2.5 GHz respectively when connected to an RF power amplifier. It can be clearly seen from the experimental data that, after being connected to the RF power amplifier, the antenna gain of the omnidirectional antenna is increased significantly.

By amplifying the RF signal with an active device (not shown) in the RF power amplifier, the gain of the omnidirectional antenna 14 is increased. Therefore, without increasing the size of the omnidirectional antenna, the high-gain omnidirectional antenna module effectively increases the transmission distance. Furthermore, as the module has the housing 18 and the base 10, the electronic elements may be covered in the housing 18 and the base 10. When the antenna module is disposed outside the vehicle in use, the electronic elements will not easily be damaged by sand or rain from outside. Therefore, the high-gain omnidirectional antenna module has a small size and good durability, and is suitable for being installed on a vehicle to serve as a wireless signal transceiver for the telematic system.

What is claimed is:

1. A high-gain omnidirectional antenna module, comprising:
a base, having a first surface and a second surface;
a radio frequency (RF) power amplifier, having an input port and an output port;
an omnidirectional antenna, having a feed portion;
a first signal line, for delivering a signal fed from outside to the input port of the RF power amplifier; and
a second signal line, for connecting the output port of the RF power amplifier and the feed portion of the omnidirectional antenna;
wherein the RF power amplifier is disposed on the base.

2. The antenna module according to claim 1, further comprising a circuit board, wherein the RF power amplifier is disposed on the circuit board.

3. The antenna module according to claim 2, further comprising a case, disposed on the circuit board.

4. The antenna module according to claim 3, further comprising a cushion, for supporting the omnidirectional antenna on the case.

5. The antenna module according to claim 2, further comprising a plurality of support members, disposed on the circuit board and the first surface of the base.

6. The antenna module according to claim 1, further comprising a plurality of support members, for supporting the omnidirectional antenna on the first surface of the base.

7. The antenna module according to claim 1, wherein the base further has a plurality of first holes, penetrating from the first surface of the base to the second surface of the base.

8. The antenna module according to claim 1, further comprising a housing.

9. The antenna module according to claim 8, wherein the base further has a plurality of second holes, penetrating from the first surface of the base to the second surface of the base.

10. The antenna module according to claim 9, wherein the first surface of the base has a groove for fastening the housing on the base, and the housing is fixed on the base by a plurality of fixing members.

11. The antenna module according to claim 1, wherein a frequency operating range of the RF power amplifier is between 2.4 GHz and 2.5 GHz.

12. The antenna module according to claim 1, wherein the base further has a third hole, penetrating from the first surface of the base to the second surface of the base, and the antenna module further comprises a waterproof joint, disposed on the second surface of the base and fixed on the third hole.
